(19) United States
(12) Patent Application Publication
(10) Pub. No.: US 2007/0014564 A1
(43) Pub. Date: Jan. 18, 2007

(54) Photographic apparatus

(75) Inventor: Mamoru Miyashita, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/478,665

(22) Filed: Jul. 3, 2006

(30) Foreign Application Priority Data
Jul. 14, 2005 (JP) 2005-205618

(51) Int. Cl. G03B 17/00

(52) U.S. Cl. 396/263

(57) ABSTRACT

The present invention provides a photographic apparatus comprising a control device which controls photography preparations when a release button is halfway-pressed and controls photography when the release button is fully-pressed, wherein the control device also controls photography upon deactivation of halfway-pressing of the release button. According to the photographic apparatus of the present invention, photography is performed not only when the release button is first halfway-pressed and then fully-pressed, but also when halfway-pressing is deactivated. This ensures even those unfamiliar with operation to perform photography without wasting photograph opportunities.

### BACKGROUND OF THE INVENTION

1. Field of the Invention

The present invention relates to a photographic apparatus, and in particular, to a photographic apparatus comprising a two-stage release button.

2. Description of the Related Art

With cameras comprising so-called AE (automatic exposure) and AF (auto focus) functions, “halfway-pressing” a release button activates AE/AF, and “fully-pressing” the release button performs photography (for instance, refer to Japanese Patent Application Laid-Open Nos. 2004-274285 and 2002-320138).

### SUMMARY OF THE INVENTION

However, distinguishing between “halfway-pressing” and “fully-pressing” of the release button proved to be difficult to those not used to operating a camera, and there was a problem where “halfway-pressing” was misinterpreted as performing photography, resulting in wasted photograph opportunities. In particular, most compact-type digital cameras require a photographer to study a display shown on a monitor provided on a camera body while taking photographs, and many mistakes occurred when using certain models because the monitor display either froze or blacked out when a release button was halfway-pressed, causing the photographer to misunderstand that photographing was achieved by halfway-pressing the release button.

The present invention has been made in consideration of such circumstances, and its object is to provide a photographic apparatus that allows even those unfamiliar with operating such apparatuses to perform photography in a fail-proof manner.

To achieve the above object, a first aspect of the present invention provides a photographic apparatus comprising a control device which controls photography preparations when a release button is halfway-pressed and controls photography when the release button is fully-pressed, wherein the control device also controls photography upon deactivation of halfway-pressing of the release button.

According to the first aspect of the present invention, photography is performed not only when the release button is first halfway-pressed and then fully-pressed, but also when halfway-pressing is deactivated. This ensures even those unfamiliar with operation to perform photography without wasting photograph opportunities.

To achieve the above object, a second aspect of the present invention provides the photographic apparatus according to the first aspect, further comprising a mode setting device for setting a photography mode to a first mode or a second mode, wherein the control device controls photography preparations upon halfway-pressing the release button and controls photography upon fully-pressing the release button when the first mode is set, while the control device controls photography preparations upon halfway-pressing the release button and controls photography upon either deactivation of halfway-pressing or upon fully-pressing the release button when the second mode is set.

According to the second aspect of the present invention, when set to the first mode, photography preparations are performed when the release button is halfway-pressed, and photography is performed when fully-pressed. On the other hand, when set to the second mode, photography preparations are performed when the release button is halfway-pressed, and photography is performed either when halfway-pressing is deactivated or when fully-pressed. Thus, according to the second aspect of the present invention, since a user may use both the first and second modes as the situation demands, operability is improved.

To achieve the above object, a third aspect of the present invention provides the photographic apparatus according to the first or second aspect wherein the photographic apparatus is a digital camera which captures images using an image capturing element and records the captured images in a storage media, the photographic apparatus further comprising: a display device which displays images captured by the image capturing element; an instruction device which instructs recording or deletion of the images displayed by the display device; and a recording control device which controls recording to or deletion from the storage media of the images captured by the image capturing device in response to instructions by the instruction device.

According to the third aspect of the present invention, an image captured by the image capturing element is once displayed by the display device prior to being recorded onto the storage media. Then, the image captured by the image capturing element is recorded onto the storage media only when an instruction for recording the image to the storage media is issued by the instruction device. This prevents unsuccessful photographed image from being recorded onto the storage media and using up resource of the storage media in vain.

The photographic apparatus according to the present invention enables even those unfamiliar with operating such apparatuses to perform photography in a fail-proof manner.

### BRIEF DESCRIPTION OF THE DRAWINGS

FIG. 1 is a front perspective view of a digital camera to which the present invention has been applied;

FIG. 2 is a rear perspective view of a digital camera to which the present invention has been applied;

FIG. 3 is a block diagram of an electrical configuration of a digital camera;

FIG. 4 is a flowchart of processing procedures during photographing with a digital camera;

FIG. 5 is a flowchart of processing procedures when recording/deleting a photographed image;

FIG. 6 is a diagram showing a display example of a preview image;

FIG. 7 is a diagram showing a display example of a preview image; and

FIG. 8 is a flowchart showing a flow of procedures for processing operations of a digital camera when a first mode is set.

### DETAILED DESCRIPTION OF THE PREFERRED EMBODIMENTS

Preferred embodiments for implementing the photographic apparatus according to the present invention will now be described with reference to the attached drawings.

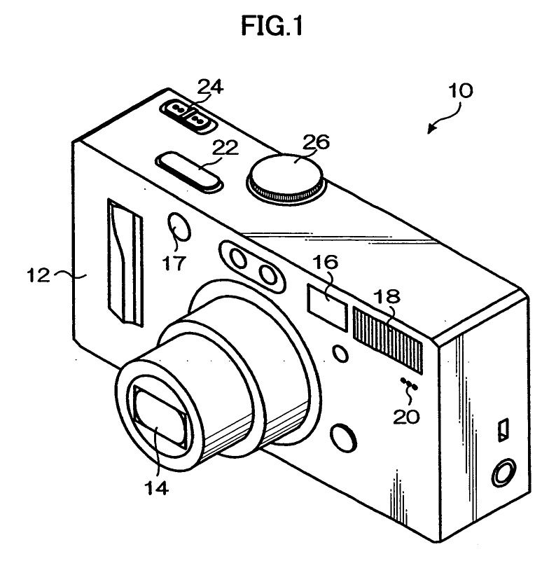

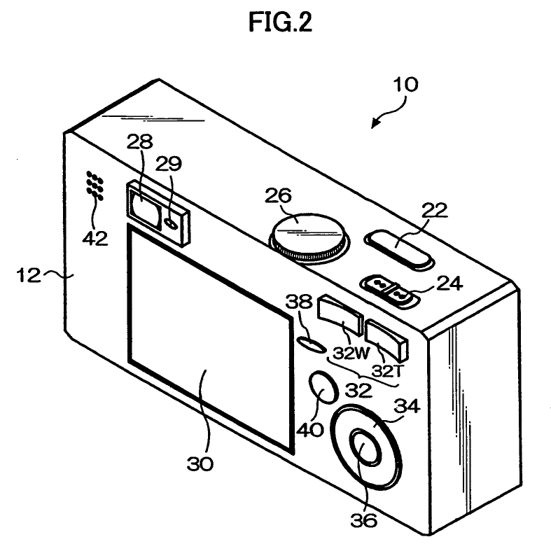

FIGS. 1 and 2 are, respectively, a front perspective view and a rear perspective view of a digital camera to which the present invention has been applied.

As shown in the drawings, a camera body 12 of a digital camera 10 according to the present embodiment is formed in a shape of a rectangular box that is elongated in a transverse direction.

As shown in FIG. 1, a photographing lens 14, a finder window 16, a self timer lamp 17, a flash 18, a microphone 20 and the like are provided on a front face of the camera body 12, while a release button 22, a power/mode switch 24, a mode dial 26 and the like are provided on a upper face thereof.

In addition, as shown in FIG. 2, a finder eyepiece 28, a finder lamp 29, a liquid crystal monitor 30, a zoom button 32, a cross-shaped button 34, a MENU/OK button 36, a DISP button 38, a BACK button 40, a speaker 42 and the like are provided on a rear face of the camera body 12.

Furthermore, although not shown, an openable and closable cover is provided on the bottom face of the camera body 12. A battery compartment for storing a battery and a memory card slot for mounting a memory card are provided inside the cover.

The photographing lens 14 is composed of a retractable zoom lens which extends out from the camera body 12 when the digital camera is powered (during photography mode).

The self timer lamp 17 is composed of a LED lamp, and during self timer photography, notifies a photographic timing to the subject by flashing and blinking at a predefined timing (for instance, the self timer lamp first lights for approximately 5 seconds, and then blinks for approximately 5 seconds before photographing is performed).

The release button 22 is composed of a two stage switch consisting of so-called “halfway-pressing” and “fully-pressing”. The digital camera 10 performs photography preparations, in other words AE, AF and AWB (automatic while balance), when the release button 22 is halfway-pressed, and performs photography when the release button 22 is fully-pressed or upon deactivation of the half-pressing. Details thereof will be provided later.

The power/mode switch 24 functions not only as a power switch which powers on/off the digital camera 10, but also as a mode switch for setting the mode of the digital camera 10, and is arranged to be slidable among an “off position”, a “playback position” and a “photography position”. The digital camera 10 is powered on when the power/mode switch 24 is set to either the “playback position” or the “photography position”, and is powered off when set to the “off position”. Furthermore, a “playback mode” is set by setting the power/mode switch 24 to the “playback position”, and a “photography mode” is set by setting the power/mode switch 24 to the “photography position”. Images may be recorded when the digital camera 10 is set to the “photography mode”, while playback of recorded images may be performed when the digital camera 10 is set to the “playback mode”.

The mode dial 26 is used to set a photography mode, and by rotating and setting the mode dial 26 to a predefined position, the photography mode of the camera may be set to a predefined mode (for instance, an automatic mode, a program mode, an aperture priority mode, a shutter speed priority mode, a manual mode or the like).

The finder lamp 29 is composed of an LED which lights and blinks according to the operating status of the digital camera. For instance, the finder lamp 29 lights during photography upon conclusion of photography preparations, and blinks when an attempt is made to perform photography below a prescribed shutter speed.

The liquid crystal monitor 30 is composed of a liquid crystal display capable of color display. The liquid crystal monitor 30 is used both as a display screen of photographed images and as a user interface when configuring various settings. In addition, live views are displayed as needed during photography, allowing the liquid crystal monitor 30 to be used as an electronic finder for confirming angles of view.

The zoom button 32 is composed of a zoom tele button 32T which instructs zooming towards a telephoto side and a zoom wide button 32W which instructs zooming towards a wide angle side. The photographing angle of view may be changed by operating the zoom button 32.

The cross-shaped button 34 is arranged to be operable by pressing in the four directions of up, down, left and right, and functions as a button for inputting instructions corresponding to each direction.

The MENU/OK button 36 functions as a button for instructing transition from the regular screens of each mode to a menu screen (MENU button), and a button for instructing finalization of selected contents and execution of processing or the like (OK button).

The DISP button 38 functions as a button for issuing instructions for switching displayed contents of the rear face display panel, while the BACK button 40 functions as a button for issuing instructions to cancel input operations or the like.

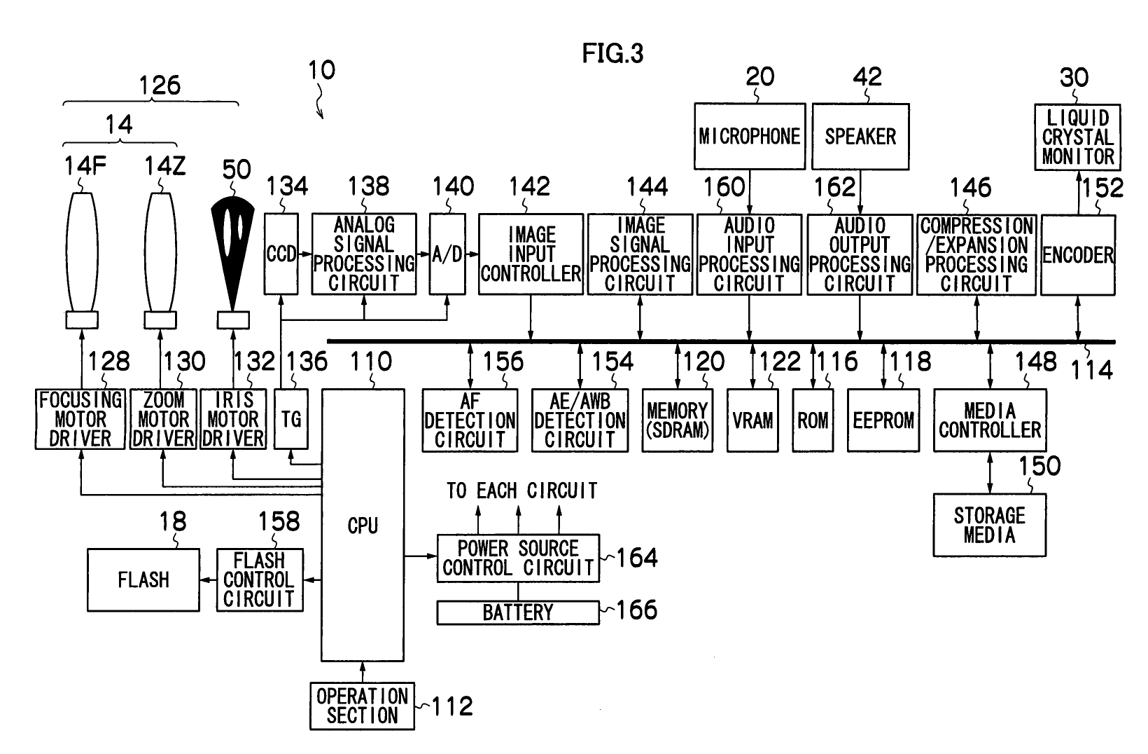

FIG. 3 is a block diagram of an electrical configuration of the digital camera 10.

As shown in FIG. 3, the digital camera 10 is composed of a CPU 110, an operation section (the release button 22, the power/mode switch 24, the mode dial 26, the zoom button 32, the cross-shaped button 34, the MENU/OK button 36, the DISP button 38, the BACK button 40 and the like) 112, a ROM 116, an EEPROM 118, a memory (SDRAM) 120, a VRAM 122, a photographic optical system 126, a focus motor driver 128, a zoom motor driver 130, an iris motor driver 132, an image capturing element 134, a timing generator (TG) 136, an analog signal processing circuit 138, an A/D converter 140, an image input controller 142, an image signal processing circuit 144, a compression/expansion processing circuit 146, a media controller 148, a storage media (memory card) 150, an encoder 152, an AE/AWB detection circuit 154, an AF detection circuit 156, a flash control circuit 158, an audio input processing circuit 160, and an audio output processing circuit 162 or the like.

The CPU 110 functions as a control section which comprehensively controls the digital camera 10, and as a processing device which performs various arithmetic processing. Based on input from the operation section 112, the CPU 110 controls each circuit according to predetermined control programs.

The ROM 116 is connected via a bus 114, and stores control programs executed by the CPU 110 and various data necessary for control. The EEPROM 118 stores user setting information and other various setting information or the like related to the operation of the digital camera 10.

The memory (SDRAM) 120 is used as a processing work area by the CPU 110, and as a temporary storage region for image data, while the VRAM 122 is used as an exclusive temporary storage region for image data to be displayed.

The photographic optical system 126 is composed of a photographing lens 14 and a diaphragm 50.

The photographing lens 14 comprises a focusing lens 14F which is driven by a focusing motor, not shown, to move back and forth along an optical axis, and a zoom lens 14Z, which is driven by a zoom motor, not shown, to move back and forth along the optical axis. The CPU 110 controls focusing of the photographing lens 14 by controlling the driving of the focusing motor via a focusing motor driver 128, and controls zoom of the photographing lens 14 by controlling the driving of the zoom motor via a zoom motor driver 130.

An aperture size (aperture value) of the diaphragm 50 varies when the diaphragm 50 is driven by an iris motor, not shown. The CPU 110 controls the aperture value of the diaphragm 50 by controlling the driving of the iris motor via an iris motor driver 132.

The image capturing element 134 is composed of a color CCD with a predetermined color filter array (for instance, a Bayer array). Light incident to the light receiving surface of the image capturing element 134 via the photographic optical system 126 is converted by each photodiodes arranged on the light receiving surface into signal charges of quantities corresponding to the incident light volume.

The timing generator (TG) 136 generates timing signals used mainly for driving the image capturing element 134 under instructions from the CPU 110. The image capturing element 134 outputs the signal charges accumulated in each photodiode as voltage signals (image signals) according to timing signals applied from the timing generator 136.

The analog signal processing circuit 138 performs correlated double sampling processing as well as amplification on image signals sequentially outputted from the image capturing element 134. The A/D converter 140 converts RGB analog image signals outputted from the analog signal processing circuit 138 into digital image signals.

The image input controller 142 has a built-in buffer memory with a predetermined capacity. The image input controller 142 accumulates one frame's worth of image signals outputted from the A/D converter 140 and stores the accumulated image signals into the memory 120.

The image signal processing circuit 144 comprises a synchronization circuit, a gamma correction circuit, a contour correction circuit, a luminance/color-difference signal generation circuit and the like, and according to instructions from the CPU 110, processes image signals stored in the memory 120 and generates YUV signals consisting of luminance signals and color-difference signals.

When displaying live views on the liquid crystal monitor 30, images are consecutively captured by the image capturing element 134, and the obtained image signals are consecutively processed to generate YUV signals. The generated YUV signals are applied to the encoder 152 via the VRAM 122 to be converted into a signal format for liquid crystal display, and are then outputted to the liquid crystal monitor 30. Live views are thereby displayed on the liquid crystal monitor 30. A user may perform adjustment of composition or focus while studying live views displayed on the liquid crystal monitor 30. In other words, photography may be performed while using the liquid crystal monitor 30 as a finder.

When recording images, images are captured by the image capturing element 134 in response to photographing instructions, and the obtained image signals are processed by the image signal processing circuit 144 to generate YUV signals. YUV signals generated by the image signal processing circuit 144 are applied to the compression/expansion processing circuit 146 to become predetermined compressed image data, and are then recorded onto the storage media (memory card) 150 via the media controller 148.

Compressed image data recorded in the storage media 150 is read out via the media controller 148 in response to a playback command, and becomes uncompressed YUV signals at the compression/expansion processing circuit 146 to be outputted to the liquid crystal monitor 30 via the encoder 152. Images recorded onto the storage media 150 are thereby displayed on the liquid crystal monitor 30.

Upon receiving a command from the CPU 110, the AE/AWB detection circuit 154 calculates a physical quantity required for AE control and AWB control from the inputted image signals. For instance, as a physical quantity required for AE control, one screen is divided into a plurality of areas (e.g. 16 by 16), and an integrated value of RGB image signals is computed for each divided area. The CPU 110 detects the luminance of a subject (subject luminance) based on the integrated values obtained from the AE/AWB detection circuit 154, and determines an aperture value and shutter speed from a predefined program diagram.

In addition, as a physical quantity required for AWB control, one screen is divided into a plurality of areas (e.g. 16 by 16), and an average integrated value for each color of the RGB image signals is computed for each divided area. The CPU 110 calculates R/G and B/G ratios for each divided area from the obtained R integrated value, B integrated value and G integrated value, and performs light source type determination based on distribution or the like in a R/G, B/G color space of the obtained values R/G and B/G. Next, according to a white balance adjustment value appropriate for the determined light source type, decides a gain value (white balance correction value) of the white balance adjustment circuit to the RGB signal so that the values of each ratio become, for instance, approximately 1 (in other words, the RGB integration ratio in one screen becomes R:G:B≈1:1:1).

Upon receiving a command from the CPU 110, the AF detection circuit 156 calculates a physical quantity required for AF control from the inputted image signals. In the digital camera 10 according to the present embodiment, it is assumed that AF control is performed based on the contrast of an image, and the AF detection circuit 156 therefore calculates a focus evaluation value, which indicates a sharpness of an image, based on input image signals. The CPU 110 drives the focusing motor via the focusing motor driver 128 to control the movement of the focusing lens 14F so that the focus evaluation value calculated by the AF detection circuit 156 assumes a maximum value.

The flash control circuit 158 controls flashing of the flash 18 according to a command from the CPU 110.

The audio input processing circuit 160 processes audio signals inputted via the microphone 20 according to a command from the CPU 110, while the audio output processing circuit 162 processes audio signals to be outputted from the speaker 42 according to a command from the CPU 110.

The advantageous effects of the digital camera 10 of the present embodiment configured as described above are as follows.

As already described, the digital camera 10 according to the present embodiment performs photography preparations, in other words AE, AF and AWB, when the release button 22 is halfway-pressed, and performs photography when the release button 22 is fully-pressed or upon deactivation of the half-pressing.

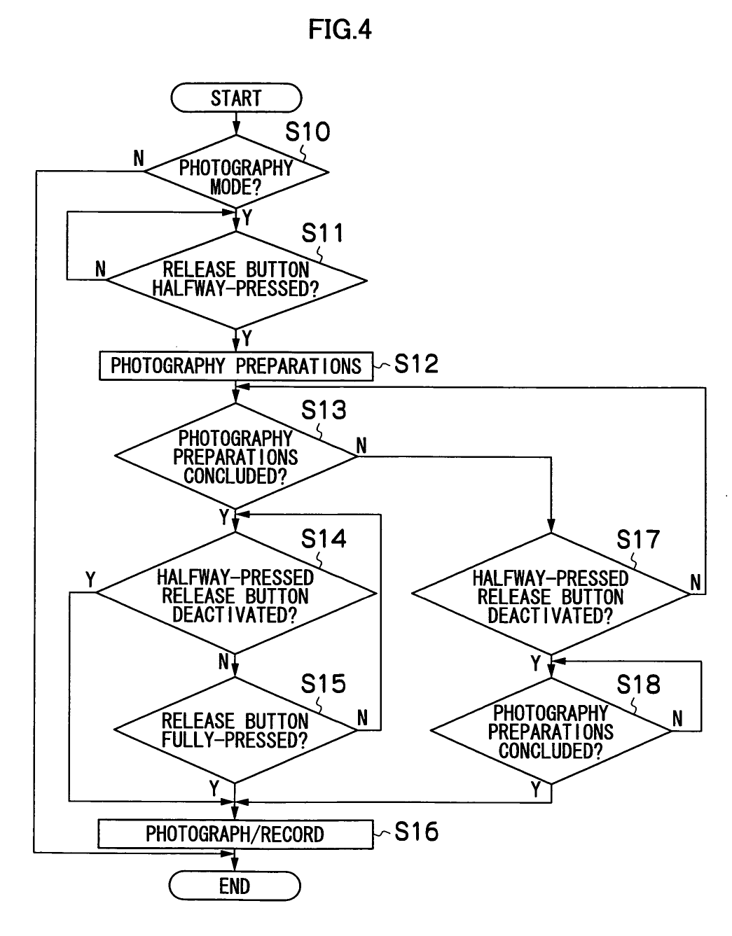

FIG. 4 is a flowchart of processing procedures during photographing using the digital camera 10 according to the present embodiment.

The CPU 110 determines whether the mode of the camera has been set to photography mode based on input from the operation section 112 (step S11).

After determining that photography mode has been set, the CPU 110 further determines whether the release button 22 has been halfway-pressed based on input from the operation section 112 (step S11).

If the release button 22 has been halfway-pressed, an S1 signal is inputted from the operation section 112 to the CPU 110 (during halfway-pressing, the S1 is always on).

Once the S1 signal is inputted, the CPU 110 determines that the release button 22 has been halfway-pressed.

After determining that the release button 22 has been halfway-pressed, the CPU 110 controls photography preparations (step S12). In other words, the CPU 110 controls AE, AF and AWB.

First, in response to the input of the S1 signal, an image to be used for photography preparations is captured by the image capturing element 134. Image signals outputted from the image capturing element 134 are loaded onto the memory 120 via the analog signal processing circuit 138, the A/D converter 140 and the image input controller 142, and then applied to the AE/AWB detection circuit 154 and the AF detection circuit 156 from the memory 120.

The AE/AWB detection circuit 154 calculates a physical quantity required for AE control and AWB control from the inputted image signals, and outputs the physical quantity to the CPU 110. The CPU 110 determines an exposure value (aperture value and shutter speed) and a white balance correction value based on the output from the AE/AWB detection circuit 154.

In addition, the AF detection circuit 156 calculates a physical quantity required for AF control from the inputted image signals, and outputs the physical quantity to the CPU 110. The CPU 110 controls driving of the focusing motor based on the output from the AF detection circuit 156, and brings the photographing lens 14 into focus on a main subject.

As seen, the CPU 110 performs photography preparations in response to halfway-pressing of the release button 22 (step S12). The CPU 110 then determines whether photography preparations have been concluded (step S13).

If photography preparations have been concluded, the CPU 110 determines whether halfway-pressing of the release button 22 has been deactivated (whether the S1 signal has been turned off) based on input from the operation section 112 (step S14).

If it is determined that the halfway-pressing of the release button 22 has been deactivated, the CPU 110 performs photography and recording processing (step S16). First, the image capturing element 134 is exposed at the exposure value obtained during the above photography preparations. Image signals outputted from the image capturing element 134 are loaded onto the memory 120 via the analog signal processing circuit 138, the A/D converter 140 and the image input controller 142, and then applied to the image signal processing circuit 144 from the memory 120. The image signal processing circuit 144 performs required signal processing on the inputted image signals to generate image data (YUV data). The generated image data is temporarily stored in the memory 120, and is then applied to the compression/expansion processing circuit 146 to be compressed to a predetermined compression format, and is once again stored in the memory 120. The CPU 110 generates for the compressed image data stored in the memory 120 an image file under a predefined format (for instance, Exif) by adding date and time of photography, aperture value, shutter speed and other attached information, and records the image file into the storage media via the media controller 148.

On the other hand, if it is determined in step S14 described above that the halfway-pressing of the release button 22 has not been deactivated, the CPU 110 determines whether the release button 22 has been fully-pressed based on input from the operation section 112 (step S15).

If the release button 22 has been fully-pressed, a S2 signal is inputted from the operation section 112 to the CPU 110 (during fully-pressing, the S2 is always on).

Once the S2 signal is inputted, the CPU 110 determines that the release button 22 has been fully-pressed.

When the CPU 110 determines that an S2 signal has been inputted from the operation section 112 and the release button 22 has been fully-pressed, the CPU 110 performs photography and recording processing in the same manner as described earlier (step S16).

On the other hand, if it is determined that the release button 22 has not been fully-pressed, the processing returns to step S14 to determine whether the halfway-pressing of the release button 22 has been deactivated.

As seen, when the release button 22 has been halfway-pressed and photography preparations have been concluded, photography will be performed not only when the release button 22 is fully-pressed but also upon deactivation of the halfway-pressing of the release button 22.

On the other hand, if it is determined in step S13 described above that the photography preparations have not been concluded, the CPU 110 determines whether the halfway-pressing of the release button 22 has been deactivated based on input from the operation section 112 (step S17).

At this point, when it is determined that the halfway-pressing of the release button 22 has not been deactivated, the CPU 110 returns to step S13 to repeat determination of whether the photography preparations have been concluded.

On the other hand, when it is determined that the halfway-pressing of the release button 22 has been deactivated, the CPU 110 determines whether the photography preparations have been concluded (step S18), and if the photography preparations have been concluded, the CPU 110 performs photography and recording processing (step S16).

As seen, when the halfway-pressing of the release button 22 has been deactivated prior to the conclusion of photography preparations, the CPU 110 waits for photography preparations to conclude and subsequently performs photography.

As described above, according to the digital camera 10 of the present embodiment, photography is performed not only when the release button 22 is first halfway-pressed and then fully-pressed, but also when the release button 22 is first halfway-pressed and the halfway-pressing is then deactivated, thereby enabling even those unfamiliar with operation to photograph and record images in a fail-proof manner.

When photography is executed, a simulated shutter sound may be outputted from the speaker 42 at the same time an image is captured by the image capturing element 134. This enables the photographer to clearly recognize that photography has been performed, and improves operability.

While the present embodiment has been arranged to always record images after photography, recording and deletion of photographed images may be arranged to be selectable.

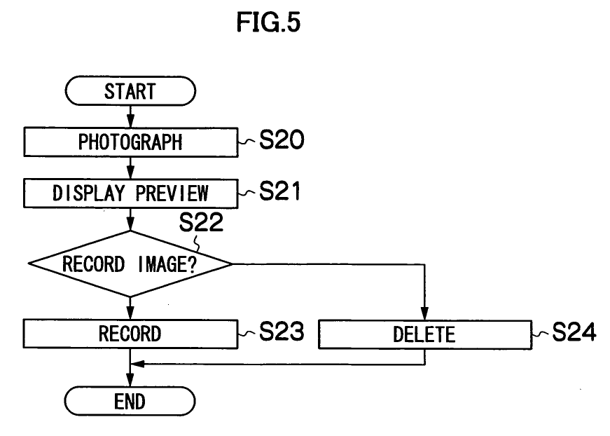

FIG. 5 is a flowchart of processing procedures when recording/deleting a photographed image.

After photography preparations, upon receiving photographing instructions, the CPU 110 performs photography processing (step S20).

First, the image capturing element 134 is exposed at the exposure value obtained during the photography preparations. Image signals outputted from the image capturing element 134 are loaded onto the memory 120 via the analog signal processing circuit 138, the A/D converter 140 and the image input controller 142, and then applied to the image signal processing circuit 144 from the memory 120. The image signal processing circuit 144 performs required signal processing on the inputted image signals to generate image data (YUV data). The generated image data is stored into both the memory 120 and the VRAM 122.

Photography preparations are hereby concluded, and the CPU 110 displays a preview of the photographed image on the liquid crystal monitor 30 (step S21). In other words, the image data stored in the VRAM 122 is applied to the encoder 152, which converts the image data into an output format for display and outputs the converted image data to the liquid crystal monitor 30. A preview of the photographed image is thereby displayed on the liquid crystal monitor 30.

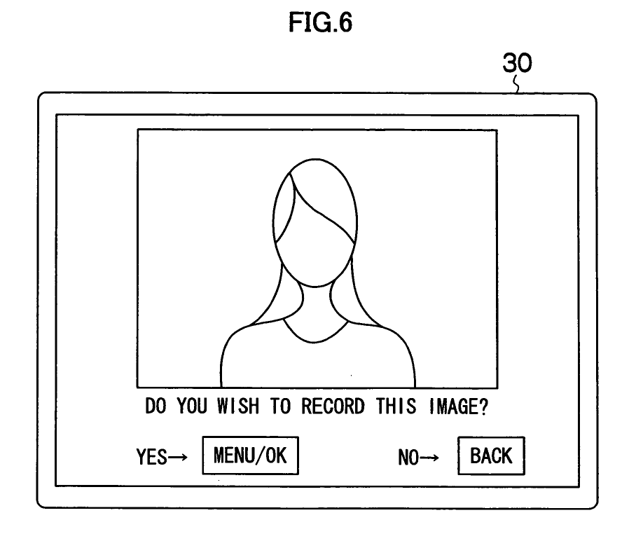

FIG. 6 is a diagram showing a display example of a preview image. As shown in FIG. 6, a photographed image is displayed together with a message (“Do you wish to record this image?”) inquiring whether the image should be recorded. The photographer may instruct recording or deletion by verifying the preview image displayed on the liquid crystal monitor 30. In the present embodiment, it is assumed that recording is instructed by pressing the MENU/OK button 36, while deletion is instructed by pressing the BACK button 40.

The CPU 110 determines whether the photographed image is to be recorded or deleted based on input from the operation section 112 (step S22). When the MENU/OK button 36 has been pressed and the CPU 110 determines that recording has been selected, the CPU 110 performs recording processing of the image (step S23). In this case, image data stored in the memory 120 is compressed by the compression/expansion processing circuit 146 to become image data of a predetermined format, and is then recorded onto the storage media (memory card) 150 via the media controller 148.

Meanwhile, when the BACK button 40 has been pressed and the CPU 110 determines that deletion has been selected, the CPU 110 deletes the image stored in the memory 120 (step S24).

As seen, by displaying previews of photographed images, and waiting for instructions to either record or delete the images before performing recording or deletion of images, only necessary images may be recorded onto the storage media 150, thereby preventing recording of unnecessary images which use up the resource of the storage media 150 in vain.

While the present example is arranged so that recording or deletion of images is performed after waiting for instructions from the photographer, the present embodiment may be arranged to automatically record photographed images when no instructions are inputted after a lapse of a certain time period after displaying preview images.

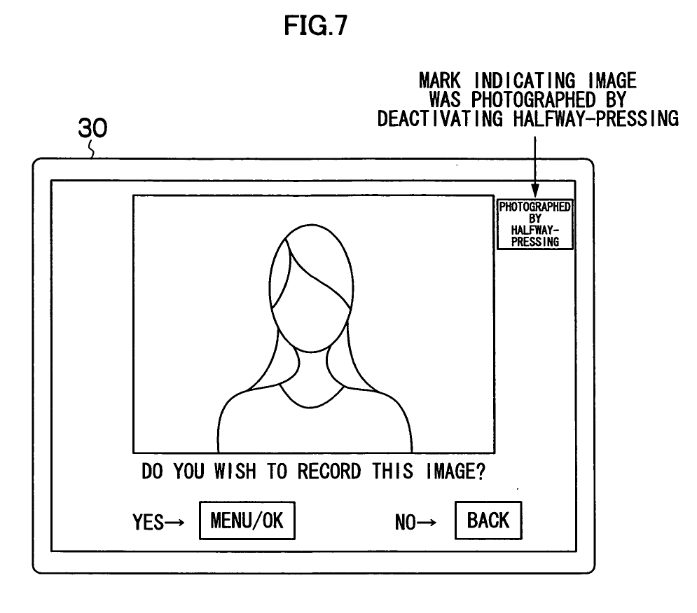

In addition, for images photographed by deactivating a halfway-pressed release button 22, it is preferable that the photographer is able to recognize that the image has been photographed by deactivating a halfway-pressed release button 22. For instance, for images photographed by deactivating a halfway-pressed release button 22, a mark indicating that the image has been photographed by deactivating halfway-pressing may be displayed on the liquid crystal monitor 30 during preview, as shown in FIG. 7. Alternatively, an audio notification may be provided through the speaker 42.

Furthermore, while the above-described embodiment is configured so that images are always recorded when halfway-pressing is deactivated regardless of a photographer's intentions, the embodiment may be configured so that the photographer may select between a mode in which images are recorded only when fully-pressed (first mode) and a mode in which images are recorded upon both fully-pressing and deactivation of halfway-pressing (second mode).

In this case, the processing operations of the above-described embodiment are executed when the second mode is selected (refer to FIG. 4), while the following processing operations are executed when the first mode is selected.

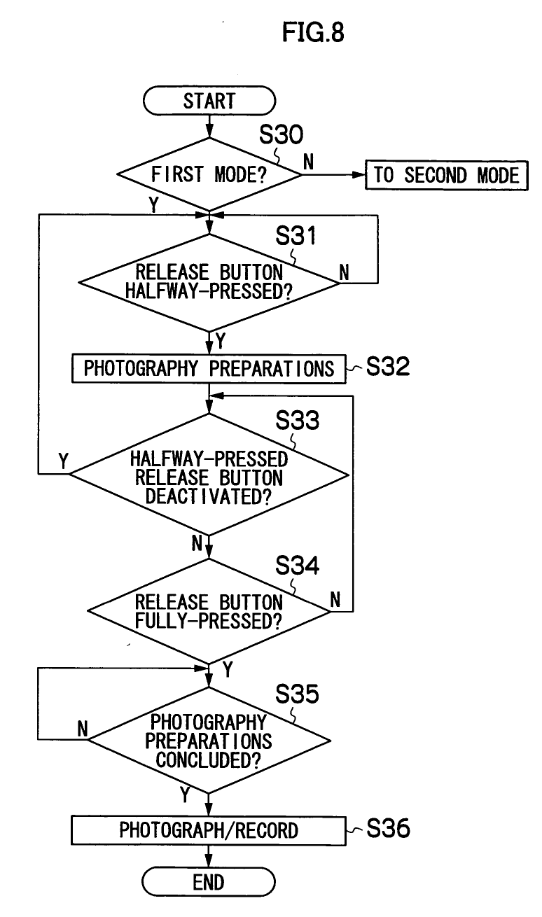

FIG. 8 is a flowchart showing a flow of procedures for processing operations of a digital camera when a first mode is selected.

First, the CPU 110 determines whether the photography mode of the camera has been set to the first mode based on input from the operation section 112 (step S30). Incidentally, the first mode or the second mode may be set using, for instance, the mode dial 26.

After determining that the first mode has been set, the CPU 110 further determines whether the release button 22 has been halfway-pressed based on input from the operation section 112 (step S31). After determining that the release button 22 has been halfway-pressed, the CPU 110 performs photography preparations (step S32). In other words, the CPU 110 controls AE, AF and AWB.

Next, the CPU 110 determines whether halfway-pressing of the release button has been deactivated (step S33), and if it is determined that the halfway-pressing of the release button 22 has been deactivated, the CPU 110 returns to step S31 to repeat determination of whether the release button 22 has been halfway-pressed.

On the other hand, if it is determined that the halfway-pressing of the release button 22 has not been deactivated, the CPU 110 next determines whether the release button 22 has been fully-pressed (step S34).

At this point, when it is determined that the release button 22 has not been fully-pressed, the CPU 110 returns to step S33 to repeat determination of whether halfway-pressing of the release button 22 has been deactivated.

On the other hand, when it is determined that the release button 22 has been fully-pressed, the CPU 110 determines whether the photography preparations have been concluded (step S35). After conclusion of photography preparations, the CPU 110 performs photography and recording processing (step S36).

As seen, in the first mode, images are recorded only when the release button 22 has been fully-pressed.

By providing the above-described first mode and a second mode in which images are recorded even upon deactivation of halfway-pressing, modes may be selected as situations demand, thereby improving usability.

While the first and second modes have been provided as photography modes in the above example, a mode in which photography is performed either upon deactivation of halfway-pressing or upon fully-pressing may be provided where photography is performed upon deactivation of halfway-pressing or upon fully-pressing only when this mode is set.

In addition, as a third mode, a mode in which photography is performed only upon deactivation of halfway-pressing may be provided.

Moreover, while an example in which the present invention has been applied to a digital camera has been described for the series of embodiments provided above, application of the present invention is not limited to this example, and the present invention may also be applied to film cameras. Furthermore, the present invention may be applied to mobile telephones comprising camera functions or video cameras comprising still image photographing functions.

What is claimed is:

1. A photographic apparatus comprising a control device which controls photography preparations when a release button is halfway-pressed and controls photography when the release button is fully-pressed, wherein
the control device also controls photography upon deactivation of halfway-pressing of the release button.

2. The photographic apparatus according to claim 1, further comprising a mode setting device for setting a photography mode to a first mode or a second mode, wherein
the control device controls:
photography preparations upon halfway-pressing the release button, and photography upon fully-pressing the release button when the first mode is set, and
photography preparations upon halfway-pressing the release button, and photography upon either deactivation of halfway-pressing or upon fully-pressing the release button when the second mode is set.

3. The photographic apparatus according to claim 1, wherein the photographic apparatus is a digital camera which captures images using an image capturing element and records the captured images in a storage media, the photographic apparatus further comprising:
a display device which displays images captured by the image capturing element;
an instruction device which instructs recording or deletion of the images displayed by the display device; and
a recording control device which controls recording to or deletion from the storage media of the images captured by the image capturing device in response to instructions by the instruction device.

4. The photographic apparatus according to claim 2, wherein the photographic apparatus is a digital camera which captures images using an image capturing element and records the captured images in a storage media, the photographic apparatus further comprising:
a display device which displays images captured by the image capturing element;
an instruction device which instructs recording or deletion of the images displayed by the display device; and
a recording control device which controls recording to or deletion from the storage media of the images captured by the image capturing device in response to instructions by the instruction device.
